(19) United States
(12) Patent Application Publication
(10) Pub. No.: US 2005/0074278 A1
(43) Pub. Date: Apr. 7, 2005

(54) Easily connected and separated columnar coupler structure

(76) Inventor: Akira Tani, Tokyo (JP)

Correspondence Address: DENNIS G. LAPOINTE;LAPOINTE LAW GROUP, PL, PO BOX 1294, TARPON SPRINGS, FL, 34688-1294, US

(21) Appl. No.: 10/667,528

(22) Filed: Sep. 22, 2003

(30) Foreign Application Priority Data
Mar. 12, 2003 (JP) 2003-066610

(51) Int. Cl. F16D 1/00

(52) U.S. Cl. 403/300

(57) ABSTRACT

An easily connected and separated columnar coupler structure comprising a first columnar coupler, for which a bolt is secured within a cylindrical joint end; a second columnar coupler, for which a nut, sized to mate the bolt, is secured within a cylindrical joint end; and a connection adaptor, having a shape and a size that permits both ends to engage the cylindrical portions of the columnar couplers, in which a bolt through-hole is formed into which, the bolt can be inserted and on which an annular projection having a greater diameter than the inner diameters of the columnar couplers is provided at an intermediate portion, wherein the columnar couplers are interconnected with the connection adaptor positioned in between. By using these columnar couplers, hollow columnar members having a cross section in a circular shape or in another shape can be tightly connected, and can be easily separated.

### BACKGROUND OF THE INVENTION

1. Field of the Invention

The present invention relates to a simple columnar coupler structure used to securely join and easily separate hollow columnar members, such as cylindrical or polygonal columnar members.

2. Related Art

Requests exist for coupling structures to be used for mounting various types of portable columnar members, such as legs for tables, desks, telephone stands and other types of furniture, and for assembling struts, such as tent poles, flagstaffs and poles used for measurement, quickly and securely and as quickly unmounted and disassembled. Especially requested are columnar members comprising short segments that can be disassembled and carried in vehicles. Furthermore, to minimize the storage space required, legs that can be disassembled must be provided for furniture.

In response to these requests, complete structures have been provided for which bolts are used to connect short members, or for a coupled pair, an embedded bolt is provided for one portion and a nut is secured to the other portion. However, using only this engagement method, tightly and securely joining one hollow cylindrical or polygonal columnar member to another is not easy.

Especially when a hollow columnar member assembly that is thus obtained (by coupling, joining and assembling) is continuously employed, junctions are easily deformed or damaged, so that bending or wobbling tends to occur at junction. Also, while for storage or moving, so-called folding furniture, such as a table or a desk having folding legs, is convenient, the legs, when extended, are unstable and make odd noises, this furniture can not appropriately convey a sense of luxury. To convey a sense of luxury, stable leg members that can be easily disassembled are required, however, coupling and separating them is troublesome.

A coupler for detachably connecting a cylindrical rod is disclosed in Japanese Utility Model Registration No. 3,066,911. In this registration, the coupler is secured to a coupling rod by a fixing machine screw, and a nut incorporated in the coupler is secured to connect the coupler to the coupling rod.

### SUMMARY OF THE INVENTION

It is one objective of the present invention to provide an easily connected and separated columnar coupler structure that can both securely join and easily separate hollow columnar members having either a circular or another cross-sectional shape.

According to the invention, an easily connected and separated columnar coupler structure comprises:
a first columnar coupler 1, for which a bolt 13 is secured at a joint end inside a cylindrical portion 11;
a second columnar coupler 2, for which a nut 23, of a size that fits over a male thread on the bolt 13, is secured at a joint end inside a cylindrical portion 21; and
a connection adaptor 3, shaped and sized so that small diameter portions 31 and 32 respectively engage the cylindrical portions 11 and 21 of the columnar couplers 1 and 2, in which is formed a bolt through hole 34, through which the bolt 13 can be inserted, and on which is provided, at an intermediate portion, a ring projection 33 having a diameter that is greater than the inner diameters of the columnar couplers 1 and 2,
wherein the columnar couplers 1 and 2 are interconnected with the connection adaptor 3 positioned in between.

According to the invention, for the columnar couplers 1 and 2, at the joint ends hollow cylindrical portions 11 and 21 are formed that fit closely over the ends (the small diameter portions 31 and 32) of the connection adaptor 3. Although it is preferable that both the cylindrical portions 11 and 21 at said joint ends have circular cross sections, so long as one of the portions has a circular cross section, the other may have a square, pentagonal or hexagonal cross section. In either case, the small diameter portions 31 and 32 of the connection adaptor 3, used for interconnecting the joint ends, must be appropriately formed and have suitable shapes and sizes that facilitate engagement.

For the easily connected and separated columnar coupler structures according to the embodiment, at the joint ends are formed cylindrical portions 11 and 21, and a bolt 13 is provided within the cylindrical portion 11 of the columnar coupler 1. The head of the bolt 13 is fixed to a bolt fixture member 12, the threaded portion projecting outward from the cylindrical portion 11. On the other hand, in a cylindrical portion 21 of the columnar coupler 2, a nut 23 is fixed to a nut fixture member 22 and is aligned so as to engage the threaded portion of the bolt 13.

The side faces of the connector adaptor 3, which is interposed between the joint ends of the columnar couplers, have shapes and sizes that permit them to closely fit the interior of the cylindrical portions at the connection ends of the columnar couplers. The ring projection 33, which has a large diameter, projects outward from the middle of the body, in the center of which is formed the bolt through hole 34 through which is inserted the bolt 13 that projects outward from one joint end.

To assemble the columnar couplers according to the invention, the bolt 13 projecting outward from one of the joint ends is passed through the through hole 34 of the connection adaptor 3, and engages the nut 23 that is secured within the other joint end. Then, the two columnar couplers are relatively rotated to secure the male thread in the nut 23.

As this fastening process advances, the small diameter portions 31 and 32, the opposed ends of the connection adaptor 3, are closely fitted into the cylindrical portions 11 and 21 that are formed in the joint ends of the columnar couplers, so that the two columnar couplers are closely joined and engaged. In this case, when the ends of the small diameter portions of the connection adaptor 3 are chamfered, the fitting process can be easily performed.

The through hole 34 of the connection adaptor 3 is formed and shaped so it corresponds to the outer diameter of the bolt 13 projecting outward from the joint end of one of the columnar couplers. Further, the small diameter portions 31 and 32 are formed so they have outer diameters and shapes that permit them to be fitted in the cylindrical portions at the joint ends of the columnar couplers.

In addition, for the connection adaptor 3, the small diameter portions 31 and 32 are tightly engaged with the cylindrical portions 11 and 21, and the play between the bolt through hole 34 and the bolt 13 is reduced. Therefore, using the bolt and the nut, the joint ends of the two columnar couplers are concentrically and securely fitted together, eliminating any instability, such as wobble or play between the columnar couplers. Aluminum, reinforced plastic or foundry die casting can be employed to constitute the connection adaptor 3.

According to the invention, the columnar coupler 1 within which the bolt 13 is fixed and the columnar coupler 2 within which the nut 23 is fixed are fitted into the inside ends of the hollow columnar members 5 and 6, which have appropriate lengths and shapes, and these columnar couplers 1 and 2 are connected by the connection adaptor 3. In this manner, the coupling of an arbitrary number of hollow columnar members is possible, and therefore, the lengths of the hollow columnar members, such as table or desk legs or struts or flagstaffs, can be arbitrarily designated.

The easily connected and separated columnar coupler structure according to the invention is appropriate for hollow columnar members, such as the legs of tables, or other furniture, that can be removed, and also for struts, such as flagstaffs, poles for signs, tentpoles or poles used for measurement. The required number of sections for a leg or a strut are closely and tightly joined together for use, while an assembled structure can be separated into individual components for storage.

### BRIEF DESCRIPTION OF THE DRAWINGS

FIG. 1 is a partially cutaway diagram for explaining an easily connected and separated columnar coupler structure according to the invention and the connection relationship of components; and

FIGS. 2A and 2B are a front view and a plan view of the structure of a connection adaptor that is interposed between the joint ends of connectable and separable columnar couplers according to the invention.

### DETAILED DESCRIPTION OF THE PREFERRED EMBODIMENT

The present invention relates to an easily connected and separated, simple columnar coupler structure whereby hollow columnar members having a cylindrical shape or a polygonal columnar shape can be securely connected and easily separated.

The preferred embodiment for the easily connected and separated columnar coupler structure of the invention will now be described while referring to the accompanying drawings. The present invention, however, is not limited to this embodiment.

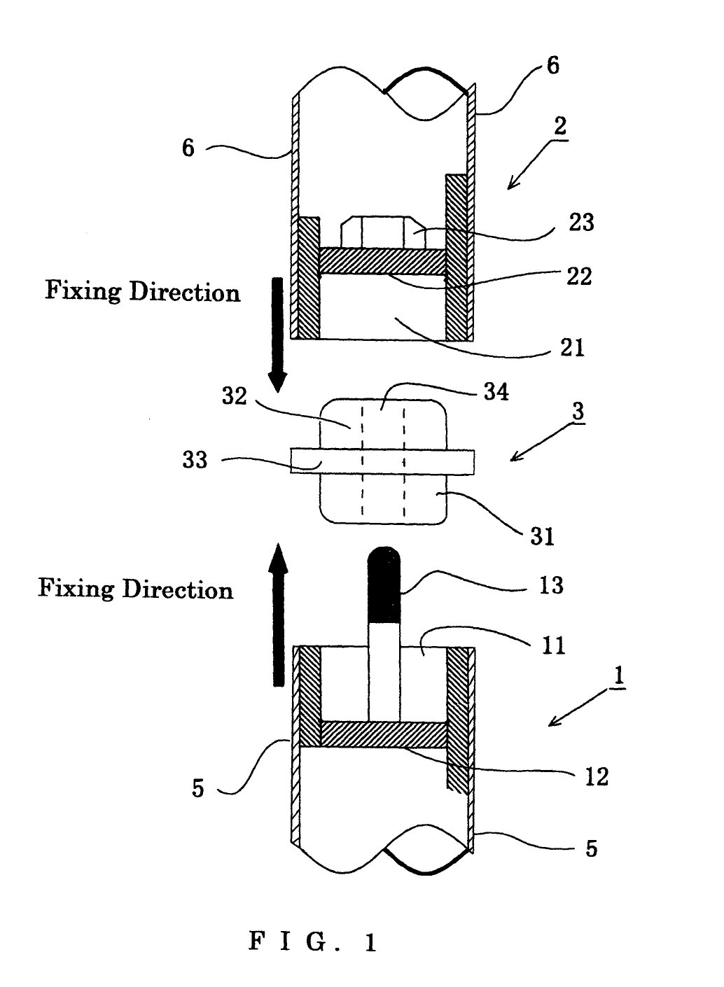

FIG. 1 is a partially cutaway diagram for explaining the easily connected and separated columnar coupler structure according to the invention and the connection relationship of the components. In the structure shown in FIG. 1, two hollow columnar members 5 and 6 are to be jointed by using a lower columnar coupler 1, an upper columnar coupler 2 and a connection adaptor 3. The lower columnar coupler 1 is fixed inside the end portion of the hollow columnar member 5, while the upper columnar coupler 2 is fixed inside the end portion of the hollow columnar member 6.

In this embodiment, the columnar couplers 1 and 2 are both cylindrical; however, the cross-sectional shape of these couplers 1 and 2 may also be a polygon, such as a pentagon, a hexagon or an octagon. To simplify the explanation, the expressions “lower” and “upper”, which are provided for the columnar couplers 1 and 2, are referred to merely when they appear in a drawing, and the upper and lower columnar couplers may be inverted or the columnar couplers may be arranged and positioned to the left and right. When three or more hollow columnar members are to be connected, two or more of the structures need merely be employed.

At the joint end of the lower columnar coupler 1, a cylindrical portion 11 is internally provided, a bolt fixture portion 12 is fixed inside the cylindrical portion 11 using appropriate means, such as welding, and an embedded bolt 13 is secured thereto so that the threaded portion projects outward from the cylindrical portion 11. At the joint end of the upper columnar coupler 2, a cylindrical portion 21 is internally provided, a nut fixture portion 22 is fixed inside the cylindrical portion 21 using appropriate means, such as welding, and a nut 23 is secured thereto.

In this embodiment, tubular members are employed as the lower and the upper columnar couplers 1 and 2. However, solid rods may be drilled out at the joint ends to form portions corresponding to the cylindrical portions 11 and 21, and a bolt may be secured in one end, while a female thread corresponding to a nut may be formed in the other end. Or, the cylindrical portion may be welded only at the joint ends.

For the connection adaptor 3, a lower small diameter portion 31 is shaped and sized so it can be fitted into the cylindrical portion 11 that is formed at the joint end of the lower columnar coupler 1. Further, an upper small diameter portion 32 is shaped and sized so it can be fitted into the cylindrical portion 21 that is formed at the joint end of the upper columnar coupler 2. An annular projection 33 is formed midway between the small diameter portions 31 and 32 of the connection adaptor 3, and has substantially the same outer diameter as the outer diameter obtained when the hollow columnar members 5 and 6 overlap the columnar couplers 1 and 2. The outer diameter of the projection 33 may be near that of each columnar coupler. In this case, the outer diameter of the projection 33 is adjusted so it corresponds to the thick outer circumference of the cylindrical portion 11 or 21 of the columnar coupler 1 or 2, and the projection 33 and the columnar couplers 1 and 2 are on the same plane when connected together. When the diameter of the projection 33 is formed so it is larger than or the same as the diameter of each columnar coupler, this portion provides another design feature for the hollow columnar member.

In this case, the same metal color type as is used for the hollow columnar member may be employed as the surface finish for the connection adaptor. However, when to provide a surface finish the hollow columnar member is chrome plated, a different metallic color, such as gold or brass, may be employed for the connector adaptor 3. Further, in the center of the connection adaptor 3, a bolt through hole 34 is formed through which the embedded bolt 13 can be passed. The outer diameter of the through hole 34 corresponds to the thickness of the bolt 13, and it is preferable there be no excessive play.

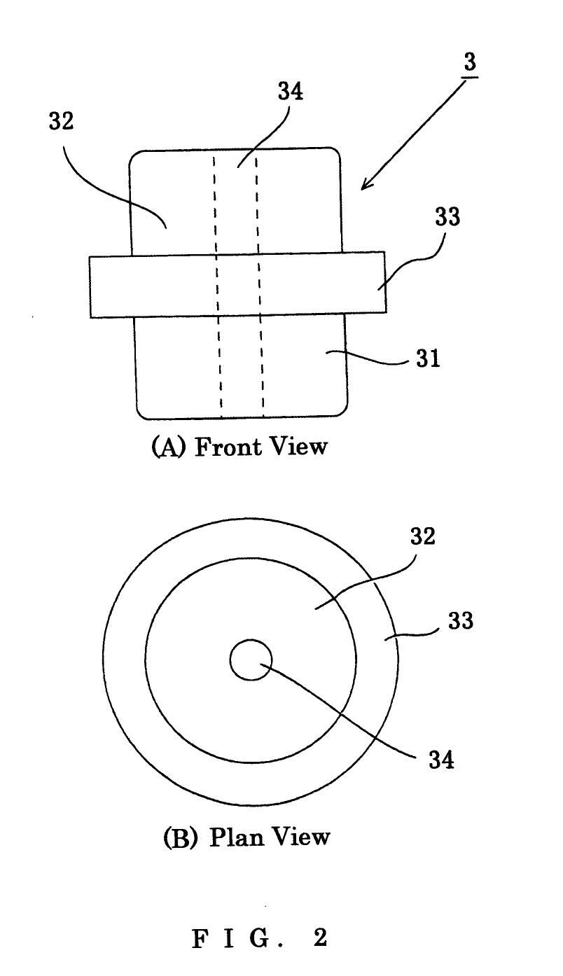

FIGS. 2A and 2B are a front view and a plan view of an example structure for the connection adaptor 3 of this invention. The same reference numerals are used as are used in FIG. 1. In this embodiment, the connection adaptor 3 is formed so that along the annular projection 33 it is symmetrically shaped. However, so long as the connection adaptor 3 can be fitted into the cylindrical portions 11 and 21 at the joint ends of the upper and lower columnar couplers 1 and 2, the connection adaptor 3 may be asymmetrically formed by changing the lengths, the thicknesses and the cross-sectional shapes of the small diameter portions 31 and 32.

Further, the shape of the connection adaptor 3 can be more varied, e.g., raised and recessed portions may be additionally formed on and in the side face of the annular projection 33. In this embodiment, the material used for the connection adaptor 3 is aluminum; however, the material that can be used is not limited to aluminum, and reinforced plastic or foundry die casting can also be employed.

The cross sectional shape of one of the upper and lower small portions 31 and 32 of the connection adaptor 3 may not always be a circle. For example, either the upper or lower cylindrical portion 11 or 21 to be engaged may have a polygonal shape so it may be employed for positioning within the hollow columnar member 5 or 6. However, in this embodiment, both of the small diameter portions 31 or 32 have circular cross sections, so that the connection adaptor 3 can be rotated relative to the columnar coupler in order to engage or disengage the bolt 13 and the nut 23. It is preferable that the end circumferences of the upper and lower small diameter portions 31 and 32 be chamfered or slightly tapered so they can be easily inserted into the cylindrical portions 11 and 21 within which they are to be fitted.

According to the invention, to join the connectable and separable columnar couplers land 2, the columnar couplers 1 and 2 are moved in the directions indicated by thick upward and downward pointing arrows in FIG. 1, which are the fixing directions. Then, the bolt 13 projecting outward from the joint end of the lower columnar coupler 1 is inserted into the through hole 34 of the connection adaptor 3, and advanced until it engages the nut 23 that is secured inside the joint end of the upper columnar coupler 2. Thereafter, the columnar couplers are rotated relatively until the male thread of the bolt 13 tightly engages the threads in the nut 23.

As this fastening process advances, the small diameter portions 31 and 32 formed on the side faces of the connection adaptor 3 are closely fitted into the cylindrical portions 11 and 21 that are formed at the joint ends of the columnar couplers 1 and 2. As a result, the two columnar couplers 1 and 2 are closely engaged and fixed. In this case, since the ends of the small diameter portions 31 and 32 of the connection adaptor 3 are chamfered or tapered, the engagement of the columnar couplers 1 and 2 can be performed easily.

According to the easily connected and separated columnar coupler structure, since the connection adaptor 3 is designed to be closely fitted into the cylindrical portions 11 and 21 of the upper and lower columnar couplers 1 and 2, these two couplers 1 and 2 can be tightly and securely engaged, and can be easily separated. As a result, when this structure is employed for the legs of furniture, such as tabled, desks, work tables, conference tables and kitchen tables, the furniture can be easily disassembled, packed away and stored when no longer required.

In this case, when a leg is removed it can be separated into several portions having shorter lengths, such as ½ or ⅓ the assembled length, so that for transport or storage the lengths are rendered more appropriate. Further, when the above described structure is employed, stable legs can be provided for furniture, and since the wobbling or odd sounds that tend to accompany the use of folding-leg furniture can be avoided, the impression that an article is inferior can be removed.

Furthermore, especially large effects can be obtained when the easily connected and separated columnar coupler structure of the invention is applied for a flagstaff, a pole for a carp banner, a pole for mounting an antenna, a structural member for a folding tent, a sign pole or a pole used for measurements, pole, which must be disassembled in order to be transported or stored.

Various other modes of carrying out the invention are contemplated that are within the scope of the following claims that in particular point out and distinctly describe the subject matter regarded as the invention.

1. An easily connected and separated columnar coupler structure comprising:
a first columnar coupler, for which a bolt is secured to a cylindrical joint end;
a second columnar coupler, for which a nut having a size that will fit over a male thread of the bolt is secured to a cylindrical joint end; and
a connection adaptor, shaped and sized so that both ends can engage said cylindrical portions of said columnar couplers, in which a bolt through hole is formed into which said bolt is inserted, and on which an annular projection having a greater diameter than the inner diameters of said columnar couplers is provided at an intermediate portion,
wherein the columnar couplers are interconnected with the connection adaptor positioned in between.

2. An easily connected and separated columnar coupler structure according to claim 1, wherein, for said columnar couplers, hollow cylindrical portions are formed at least in the vicinities of joint ends so as to be closely fitted over ends of said connection adaptor.

3. An easily connected and separated columnar coupler structure according to claim 2, wherein at least one of said cylindrical portions of said joint ends has a circular cross section.

4. An easily connected and separated columnar coupler structure according to one of claim 1, wherein said inner diameters at said ends of said connection adaptor are formed and sized so that said ends can be fitted inside said ends of said columnar couplers; and wherein both of said ends are chamfered so that an assembly process can be easily performed.

5. An easily connected and separated columnar coupler structure according to one of claim 1, wherein said first columnar coupler wherein said bolt is secured and said second columnar coupler in which said nut is secured are fitted inside ends of hollow columnar members having appropriate lengths and shapes; and wherein said columnar couplers are connected by using said connection adaptor, so that coupling for an arbitrary number of said hollow columnar members is enabled.

6. An easily connected and separated columnar coupler structure according to one of claim 1, wherein a material used for said connection adaptor is aluminum, reinforced plastic or foundry die casting.

7. An easily connected and separated columnar coupler structure according to one of claim 5, wherein said hollow columnar members are legs for a table or other furniture, a flagstaff, a sign pole, a tent pole, or a measurement pole or another strut.
